(19) United States
(12) Patent Application Publication
(10) Pub. No.: US 2022/0340007 A1
(43) Pub. Date: Oct. 27, 2022

(54) Pedal Module with Actuator

(71) Applicant: Kyocera AVX Components (Werne) GmbH, Werne (DE)

(72) Inventors: Thorsten Möller, Selm (DE); Roger Möllers, Dülmen (DE)

(21) Appl. No.: 17/725,949

(22) Filed: Apr. 21, 2022

(30) Foreign Application Priority Data
Apr. 22, 2021 (DE) DE102021110352.5

(51) Int. Cl. B60K 26/02

(52) U.S. Cl. CPC B60K 26/021; B60K 2026/022

(57) ABSTRACT

The example aspects of the present disclosure relates to a pedal module, with an electromechanical actuator, and with a base body, having an inner space and in the inner space, a pedal mechanism with a restoring unit, as well as an actuation plate, wherein the base body and actuation plate are connected to one another such that the actuation plate is rotatably mounted on the base body. Moreover, the pedal module has a coupling element, having a first end and a second end, wherein the coupling element in the region of the first end is situated in operative connection with the pedal mechanism and in the region of the second end is situated in operative connection with the actuation plate. To propose a pedal module with an actuator which has a simple, cost-effective and low-maintenance construction, and moreover ensures the generation of easily usable tactile signals, it is provided that the coupling element has a cavity in which the electromechanical actuator is disposed.

### FIELD

Example aspects of the present disclosure relate to a pedal module with an electromechanical actuator.

### BACKGROUND

An accelerator pedal is known from DE 10 2010 027 924 A1, which has a base element and a pedal element attached to it. The pedal element can be deflected between a basic position and an actuating position. An actuating force unit is further provided between the base element and the pedal element in order to apply a force against an actuating direction of the pedal element. This actuation force unit comprises a telescopic housing with an electromagnet unit and a ferromagnetic threshold element. Furthermore, a return spring is arranged in the housing. The electromagnet unit can be energized in such a way that it exerts an attractive force on the threshold element. From a predetermined deflection, the attractive force is added as a force peak to the force required for the further movement of the pedal element.

A method for tactile notification of binary warning signals in a motor vehicle is known from DE 25 55 429. Moreover, a corresponding pedal device having a pedal plate mounted on a spring is disclosed. An electromechanical vibrator acts as a counter bearing on the spring, said vibrator being controllable by a limit value element which is influenced by a measured value. If the measured value exceeds a preset limit value, a haptic signal is transmitted from the vibrator to the pedal plate through the spring.

Furthermore, an accelerator pedal unit with a pedal plate having a tread on its top and a lever on the back is known from DE 10 2011 081 071 A1. The pedal plate is pivotably mounted in a support device. A receiving device for an electromagnet with a plunger is disclosed on the back of the pedal plate, near the lever. The electromagnet can be actuated such that a ferromagnetic plunger assigned to it is periodically brought into contact with the back of the pedal plate. A tangible knocking or ticking can thus be transmitted to the pedal plate.

Furthermore, a gas pedal which is rotatably mounted at a first end to a bearing block fixed in place is known from DE 27 54 813. Further, in the region of a second end, the gas pedal has a curved rod made of a soft-magnetic material. With its free end, the rod plunges into a coil, with which it together forms a small vibrator. Moreover, a sensory unit for monitoring operating parameters, capable of additionally actuating the vibration of the small vibrator accordingly, is assigned to the coil.

Finally, another gas pedal is known from DE 100 26 048 C2, which comprises a vibration device in the gas pedal itself for haptic signaling. The vibration device is connected to the gas pedal housing and completely enclosed by it. The vibration device is connected by a cable to an external control unit which is especially designed to trigger the haptic signal. The cable is simply laid out of the gas pedal housing.

Some known gas or accelerator pedals have an elaborate and/or fault-prone construction. The actuators and/or their connection devices are often hardly protected against outer influences and give rise to high costs, such as in the event of a replacement, including due to their complex arrangement.

### SUMMARY

Aspects and advantages of embodiments of the present disclosure will be set forth in part in the following description, or may be learned from the description, or may be learned through practice of the embodiments.

One example aspect of the present disclosure is directed to a pedal module. The pedal module includes an electromechanical actuator. The pedal module includes a base body having an inner space. In the inner space is a pedal mechanism with a restoring unit. The pedal module includes an actuation plate. The base body and the actuation plate are connected to one another such that the actuation plate is rotatably mounted on the base body. The pedal module includes a coupling element having a first end and a second end. The coupling element in the region of the first end is situated in operative connection with the pedal mechanism and in the region of the second end is situation in operative connection with the actuation plate. The coupling element is rigid and has a cavity in which the electromechanical actuator is disposed.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts a pedal module with actuator according to example embodiments of the present disclosure in a lateral section view in resting position;

FIG. 2 depicts the pedal module according to FIG. 1 in actuated position.

### DETAILED DESCRIPTION

The pedal module according to example aspects of the present disclosure comprises a base body which in turn has an inner space, and in the inner space, a pedal mechanism with a restoring unit. The base body is not limited to a shape, thus can be designed variously, such that the pedal module can be used accordingly flexibly. Within the scope of example aspects of the present disclosure, the inner space is spanned accordingly by the base body. Moreover, within the scope of the intended use, the base body is especially fixed in place and immovably disposed in a foot space of a vehicle. Irrespective of whether the base body has one or more openings or partially opened outer surfaces, such as for guiding through cables or other implements, within the scope of example aspects of the present disclosure the base body can span an inner space. Within the scope of example aspects of the present disclosure, aside from the restoring unit, a pedal mechanism can be understood as, for example, a structural unit in the inner space of the pedal module which on the one hand, serves in mechanical ways for a haptic force progression (e.g., hysteresis curve) upon actuation of the pedal module, which is described in more detail below. On the other hand, apparatuses that interoperate with a sensor system, which in turn influences a parameter of a device coupled to the pedal module, e.g., of a vehicle engine or the like, can also be understood under the pedal mechanism within the scope of example aspects of the present disclosure. An electrical influencing can thus take place, e.g., by way of output of a control signal.

The pedal module according to example aspects of the present disclosure further comprises an actuation plate, wherein base body and actuation plate are connected to one another such that the actuation plate is rotatably mounted on the base body. Generally, a pedal module is provided as a control element for foot actuation by a user. An actuation plate within the scope of example aspects of the present disclosure can be understood especially as a flat component having a top for placement of the foot of the user and a back facing toward the base body. The actuation plate can especially comprise an end section, with which it is rotatably mounted on the base body. This can be realized, for example, in the form of a hinge-like connection of actuation plate and base body, or however via an additional separate connection element, such as a film hinge, or the like.

Furthermore, the pedal module according to example aspects of the present disclosure comprises a coupling element, itself having a first end and a second end, wherein the coupling element in the region of the first end is situated in operative connection with the pedal mechanism and in the region of the second end, is situated in operative connection with the actuation plate. Within the scope of example aspects of the present disclosure, the coupling element can be designed as a single piece or multiple pieces, such as from a metal or a plastic. The material especially fulfills requirements for mechanical durability. The coupling element can further have, for example, a round, but also a rectangular cross-section. At the previously mentioned ends, the coupling element can comprise respectively same or different means for fastening to actuation plate or pedal mechanism. It is further also conceivable that the fastening or connection takes place as a material fit, instead of as a form fit or force fit. Within the scope of example aspects of the present disclosure, the coupling element is connected, in the region of the previously mentioned back facing, to the actuation plate.

Within the scope of example aspects of the present disclosure, the coupling element can be understood as that part of the pedal module via which an actuation of the actuation plate, especially by the foot of the user, is transmitted to the pedal mechanism. Operative connection can thus also be understood accordingly to mean that actuation plate and pedal mechanism not only contact one another indirectly via the coupling element, but rather are also impulse-coupled or operatively coupled. Thus, when the actuation plate is actuated, the coupling element conducts the corresponding impulse or the corresponding movement to the pedal mechanism. In a resting position of the pedal module, in which the actuation plate is not actuated, the coupling element can hold the actuation plate in a maximal deflection to the base body. This maximal deflection can be understood as effective range, i.e., the range within which the actuation plate can be maximally displaced. This effective range is also referred to as pedal angle range. Within the scope of example aspects of the present disclosure, the restoring unit thereby exerts, for example, in such a way a constant force on the pedal mechanism that induces the actuation plate to distance itself from the base body by means of the coupling element. The restoring unit can thus return the actuation plate to the previously mentioned resting position after actuation takes place.

The above-mentioned force progression of the actuation generated by the pedal mechanism is essentially evident due to friction and damping. The pedal mechanism is thus mounted, for example, on frictional components or the like such that the pedal mechanism exerts a resistance against the actuation within the scope of the actuation transmitted through the coupling element. The corresponding resistance force can be linear, but can also be adjusted to a hysteresis curve over the course. All of this is especially intended to give the user a significant haptic feeling upon actuating the pedal module.

It is characteristic of the pedal module according to the example aspects of the present disclosure that the coupling element has a cavity in which an electromechanical actuator is disposed.

Various component units which, for example, are especially suited to converting an electrical signal into a mechanical movement or into a tactile signal can be understood as actuators. Within the scope of example aspects of the present disclosure, such component units can represent, for example, electric motors with an imbalance disposed on the shaft or electromagnets with plunger. These are suited, for example, for generating tactile signals in the form of vibrations, knocks, ticks, or the like.

The coupling element can be designed, for example, as a round or rectangular tube. In this context, the cavity would then be continuously designed, for example. However, it is also conceivable within the scope of example aspects of the present disclosure that the coupling element comprises a cavity independent of its cross-section which cavity is at least partially closed in the region of the first and/or of the second end. Correspondingly, it can be conceivable, for example, to implement a coupling element in a multi-part manner with a cavity closed in the region of both aforementioned ends in order to thus simplify the disposition of the actuators in the cavity.

The pedal module according to example aspects of the present disclosure has an increased mechanical load capacity and yet a simple construction. The actuator is designed with regard to its disposition to be protected against outer mechanical influence and moreover, also against contaminants. Additionally, an augmented effectiveness of the tactile signal transmission is achieved by the special disposition of the actuator according to example aspects of the present disclosure within the coupling element. Compared to known pedal modules with actuators, the pedal module according to example aspects of the present disclosure is advantageous.

As demonstrated above, according to example aspects of the present disclosure, the coupling element is connected in the region of its first end to the pedal mechanism, which is disposed in the inner space of the base body. Correspondingly, the coupling element can protrude through the base body, for example, by means of an access opening, or the like.

It can be advantageous in this context to have access to the cavity in the coupling element directly from the inner space, for example, to place lines or the like in the cavity without them having contact with the surroundings of the base body. According to an embodiment therefore, the inner space and the cavity are in contact with one another by means of an opening in the region of the first end of the coupling element.

The above-mentioned opening has especially, as previously suggested, the purpose of leading at least supply lines or the like directly in the inner space from the cavity. The opening can also have other dimensions, however. For example, it is conceivable that the opening is even large enough to bring the actuator itself through it into the cavity. The advantage of this disposition is especially that contact between all components disposed in the pedal module related to the functioning of the electromechanical actuator and the surroundings is avoided. According to a further embodiment, the electromechanical actuator comprises an electrical contact lead which therefore runs through the opening in the coupling element into the inner space of the base body. The electrical contact lead correspondingly serves, on the one hand, for power supply of the actuator, and on the other hand, also for electrical signal transmission. The actuator can also be connected via such a contact lead, for example, to a control or regulation unit which especially is designed for targeted actuation of the actuator.

According to a further embodiment, the cavity in the coupling element accounts for more than 40%, such as more than 50%, such as more than 60% of a longitudinal extension of the coupling element between pedal mechanism and actuation plate. This especially has the advantage that from a technical perspective, a hollow profile has a greater breaking strength than a solid profile. Moreover, the transmission of a tactile signal through the coupling element toward the actuation plate, with regard to the intensity of the signal reaching the user, depends on the dimension of the cavity, apart from material properties. Aside from, for example, a solid design in the region of the first and second end, i.e., in the connection regions to the actuation plate and pedal mechanism, influence can be exerted on the design of a central section with higher breaking strength of the coupling element through an intentional design of the cavity.

To transmit a tactile signal as intensively as possible to the user or driver, it can moreover be advantageous to dispose the actuator near the actuation plate. The farther the actuator is from the actuation plate, the greater the corresponding energy loss of the signal impulse can be. According to a further preferred embodiment, the electromechanical actuator is disposed at the position in the coupling element closest to the actuation plate. Transmitting a tactile signal to the actuation plate has especially safety-related advantages. Thus, for example, an actuator of the present type can be actuated specifically when the user, for example, the driver of a vehicle equipped with a pedal module, is to make aware of a danger, a misconduct, or the like. Specifically, such factors in which the actuation of the actuator can be advantageous can be the exceeding of permitted driving times or speeds, obstacles, faulty components, or the like.

Alternatively, it can be advantageous to increase the safety of the actuator and thereby to place the above-mentioned advantages of an essentially hollow embodiment of the coupling element in the background, e.g., when a corresponding pedal module is to be used, for example, in industrial vehicles. As is commonly known, in that context higher mechanical loads act on the coupling element. According to a further preferred embodiment, the coupling element is therefore designed essentially solid and the electromechanical actuator is encapsulated in the coupling element. This can be achieved, for example, by making the cavity in such a case accessible from the outside in a compartment-like manner. An essentially solid formation of the coupling element can additionally have the advantage of higher flywheel mass and a direct impulse transmission.

As demonstrated in the preceding, the coupling element has the entirely fundamental object inter alia of transmitting the actuation of the actuation plate to the pedal mechanism. To design such a transmission directly and losslessly, it can therefore be advantageous for the coupling element to have, for example, low damping. According to a further embodiment , the coupling device is therefore designed rigid. It is conceivable, however, that in other configurations the coupling element is designed, for example, at least partly elastic, telescopic, or the like.

As demonstrated in the preceding, each control point on the actuation plate is moved on a circular path during the actuation due to the rotatable mounting of said actuation plate on the base body. This also applies accordingly, for example, to the second end of the coupling element, which is situated in operative connection with the actuation plate. It is therefore correspondingly advantageous if the type of the connection of the coupling element to the actuation plate or to the base body is designed such that the coupling element does not oppose the actuation so to impede or even to block it. According to a further embodiment, the coupling element is therefore hinged to the actuation plate and/or to the pedal mechanism. If the coupling element is hinged to the actuation plate and/or pedal mechanism, it is possible that the angle in which the coupling element is oriented to the actuation plate or to the pedal mechanism, respectively, adapts accordingly during the actuation. Accordingly articulated connection types are known from the prior art.

It can be further advantageous for the actuation of the actuation plate transmitted to the pedal mechanism to also be directly translated into an electric signal. With such a signal, as described above, especially parameters of a device assigned to the pedal can be controlled. The pedal module can thus be used, for example, as a gas pedal in a motor vehicle, truck, or the like. According to another embodiment, the pedal mechanism has an actuation lever wherein the coupling element in the region of its first end is situated in operative connection with the actuation lever. The actuation lever can be mounted especially rotatably at a center of rotation, wherein this center of rotation is preferably disposed in the region of one end of the actuation lever facing away from the connection region to the coupling element. The connection of the actuation lever to the first end of the coupling element is accordingly preferably distanced from the center of rotation in order to exert a lever action on the center of rotation by means of the actuation.

As mentioned above, means for generating a force progression for the actuation, for example, can be disposed in the region of the center of rotation in order to improve the haptic feeling of the actuation for the user. It is further possible that a sensor, chip, or the like is disposed in the actuation lever, which sensor, chip, or the like interacts with a detection unit disposed in the inner space. During the actuation then, for example, the position of the chip relative to the detection unit changes such that as a result, a conclusion about the degree of the actuation is possible. The degree of the actuation can then be converted into a correspondingly variable electric control signal and used to, as mentioned above, for example, influence a parameter of a device, for example, of an engine coupled to the pedal module. It is further possible that the axis of the center of rotation is coupled in turn with a transducer and a corresponding electric control signal is generated regarding the degree of rotation.

The restoring unit can be disposed in the inner space such that it applies the constant restoring force to the actuation lever from the opposite direction as the direction of the actuation. The restoring unit can then be designed, for example, as a spring, especially a redundantly designed double spring or as an otherwise designed force store. Here, such a force store is preferably an elastic element which responds to pressure with deformation and releases the essentially stored pressure force in the opposite direction when it is again unloaded.

Example tactile signals for information or warning a user are especially vibration or knocking/ticking, as mentioned above. Vibration can have advantages in this context, such as, for example, easier perception and better transmissibility. According to a further embodiment, the electromechanical actuator is therefore designed as a vibration element. It is conceivable to use a combined actuator that is capable of emitting both a vibrating as well as a tactile signal. The combination of an electromagnet with a plunger is especially known as knocking or ticking actuators.

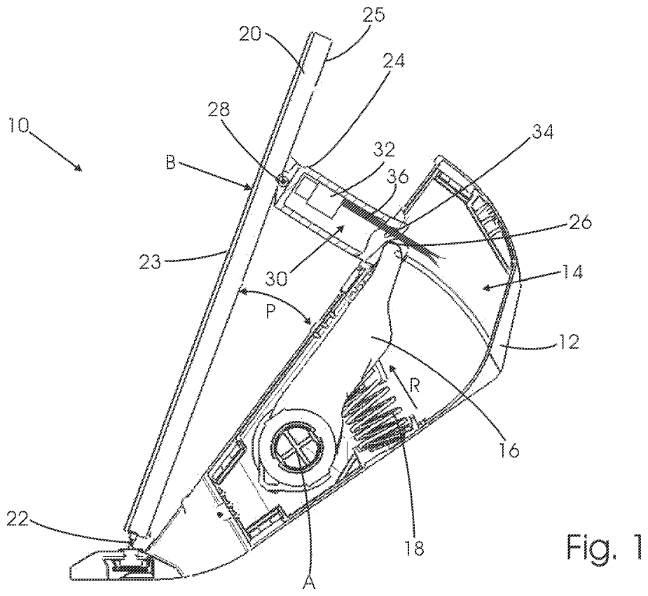

FIG. 1 shows a schematic construction of a pedal module 10, with a housing 12 and an actuation plate 20. The actuation plate 20 is rotatably mounted to the housing 12 at a film hinge 22. The housing 12 spans an inner space 14 in which are disposed an actuation lever 16 mounted about an axis of rotation A and a mounted return spring 18 acting thereupon. In the region of the axis of rotation A, the actuation lever 16 is connected to a control unit, not shown here, for output of a control signal.

As FIG. 1 further shows, the return spring 18 constantly imprints a restoring force R to the actuation lever 16 in the direction of the actuation plate 20. The actuation plate 20 has a top 23 and a bottom 25, wherein the top 23 is provided for placing the foot of a user and correspondingly for actuating the pedal module 10 by applying pressure by means of an actuation force B to the top 23. At the bottom 25 the actuation plate 20 is connected to a coupling element 24 by means of a connection joint 28. As FIG. 1 further illustrates, the coupling element 24 is connected at its other end to the actuation lever 16 within a connection region 26. The actuation lever 16 is constantly loaded with the restoring force R, as mentioned above, however the movement of the actuation lever 16 in the direction of the actuation plate 20 is limited by the housing 12.

In FIG. 1, the coupling element 24 is essentially disposed outside the inner space 14 between the actuation plate 20 and the actuation lever 16 or the housing 12. The pedal module 10 is unactuated here and is in a resting position. Correspondingly, in the resting position the actuation plate 20 has the maximal distance to the housing 12 at all points. Due to the mounting at the film hinge 22, an angle is spanned between actuation plate 20 and housing 12, which in the resting position correlates to a pedal angle range P. The pedal angle range P indicates the maximal actuation path of the actuation plate 20 or of the pedal module 10 itself.

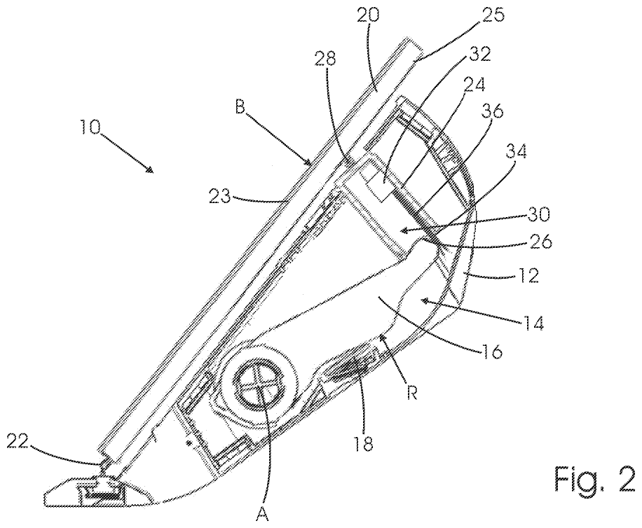

Conversely, the representation according to FIG. 2 illustrates the case of a maximally actuated pedal module 10. The return spring 18 is maximally compressed here. The coupling element 24 is situated largely inside the inner space 14. The pedal angle range P is moreover completely utilised.

As FIGS. 1 and 2 illustrate, the coupling element 24 comprises a cavity 30. A vibration motor 32 with an electric contact lead 36 is arranged as an actuator in the cavity 30. The vibration motor 32 is supplied with power via the contact lead 36, on the one hand, and is actuated by a control unit (not shown), on the other hand. The vibration motor 32 is disposed in the cavity 30 at the closest position to the actuation plate 20. Here, the vibration motor 32 is glued, for example, into the coupling element 24.

The above pedal module 10 is installed as an accelerator pedal in a motor vehicle not shown here in more detail. The pedal module 10 or the vibration motor 32 respectively can be actuated by the electronics of the vehicle. Events in which an actuation of the vibration motor 32 can especially be performed are, for example, speeding, a technical defect, lack of fuel, black ice warning, or the like. The vibration motor 32 is moreover designed to be excited to various vibration modes. A simple periodic vibration can therefore, for example, indicate exceeding a speed, while a varying vibration, for example, can indicate an acute lack of fuel. A basic excitation or usage of various vibrational modes of a vibration motor 32 can be used, for example, in a similar manner as for smartphones.

1. A pedal module, comprising
an electromechanical actuator,
a base body, having an inner space and in the inner space, a pedal mechanism with a restoring unit,
an actuation plate, wherein base body and actuation plate are connected to one another such that the actuation plate is rotatably mounted on the base body,
a coupling element, having a first end and a second end, wherein the coupling element in the region of the first end is situated in operative connection with the pedal mechanism and in the region of the second end, is situated in operative connection with the actuation plate,
wherein
the coupling element is rigid and has a cavity in which the electromechanical actuator is disposed.

2. The pedal module according to claim 1, wherein the inner space and the cavity are in contact with one another by an opening in the region of the first end of the coupling element.

3. The pedal module according to claim 2, wherein the electromechanical actuator has an electric contact lead which runs through the opening in the coupling element into the inner space of the base body.

4. The pedal module according to claim 1, wherein the cavity in the coupling element occupies more than 40% of a longitudinal extension of the coupling element between pedal mechanism and actuation plate.

5. The pedal module according to claim 4, wherein the electromechanical actuator is arranged at the position in the cavity closest to the actuation plate.

6. The pedal module according to claim 1, wherein the coupling element is essentially solid and the electromechanical actuator is encapsulated in the coupling element.

7. (canceled)

8. The pedal module according to claim 1, characterized in that the coupling element is hinged to the actuation plate or to the pedal mechanism.

9. The pedal module according to claim 1, characterized in that the pedal mechanism has an actuation lever, wherein the coupling element in the region of its first end is situated in operative connection with the actuation lever.

10. The pedal module according to claim 1, characterized in that the electromechanical actuator is designed as a vibration element.
